(19) United States
(12) Patent Application Publication
(10) Pub. No.: US 2021/0295156 A1
(43) Pub. Date: Sep. 23, 2021

(54) NON-TRANSITORY COMPUTER-READABLE STORAGE MEDIUM FOR STORING MACHINE-LEARNING PROGRAM, MACHINE-LEARNING METHOD, AND INFORMATION PROCESSING DEVICE

(71) Applicant: FUJITSU LIMITED, Kawasaki-shi (JP)

(72) Inventor: Koji MARUHASHI, Hachioji (JP)

(73) Assignee: FUJITSU LIMITED, Kawasaki-shi (JP)

(21) Appl. No.: 17/201,646

(22) Filed: Mar. 15, 2021

(30) Foreign Application Priority Data
Mar. 19, 2020 (JP) 2020-050214

(51) Int. Cl. G06N 3/08

(52) U.S. Cl. CPC G06N 3/08

(57) ABSTRACT

A method includes: generating common information to be commonly applied to plural input data each including a combination of a value of each item and an input value in association with one or more items, the common information being for converting a correspondence between each input value and each input node in a machine learner in a case of inputting the plural input data to the machine learner; generating individual information to be individually applied to each input data, the individual information being for converting the correspondence, in association with a remaining item excluding the one or more items, by using a similarity between test data and collation data obtained by converting the correspondence; generating converted data obtained by converting the correspondence by using the generated common conversion information and the generated individual conversion information; and updating the collation data and the machine learner by using the generated converted data.

### CROSS-REFERENCE TO RELATED APPLICATION

This application is based upon and claims the benefit of priority of the prior Japanese Patent Application No. 2020-50214, filed on Mar. 19, 2020, the entire contents of which are incorporated herein by reference.

### FIELD

The embodiment discussed herein is related to a non-transitory computer-readable storage medium storing a learning program, a learning method, and an information processing device.

### BACKGROUND

In the past, there has been a machine-learning technique using a neural network. For example, an information processing device inputs each of a plurality of input values included in input data to each of a plurality of nodes in an input layer of the neural network, and performs learning (i.e., training) of the neural network on the basis of an output error between output data of the neural network and teaching data.

For example, there is prior art using collation data in which a criterion for converting a correspondence between each of a plurality of nodes of an input layer of a neural network and each of a plurality of input values included in input data is represented by an array of a plurality of criterion values. For example, an information processing device inputs each of a plurality of input values included in input data to a neural network according to a correspondence based on collation data, and updates the neural network and the collation data on the basis of an output error between output data of the neural network and teaching data.

Example of the related art includes Japanese Laid-open Patent Publication No. 2018-055580.

### SUMMARY

According to an aspect of the embodiments, provided is a machine-learning method (may be referred to as “learning method”) implemented by a computer. In an example, the machine-learning method includes: generating common conversion information to be commonly applied to a plurality of data, each of the plurality of data including a combination of an item value of each item of a plurality of items and an input value in association with one or more items of the plurality of items, the common conversion information being for converting a correspondence between each of the input values in the plurality of data and each of input nodes in a machine learner in a case of inputting the plurality of data to the machine learner; generating individual conversion information to be individually applied to each of the plurality of data, the individual conversion information being for converting the correspondence of each of the plurality of data, in association with a remaining item excluding the one or more items of the plurality of items, on the basis of a similarity between test data and collation data obtained by converting the correspondence for each of the plurality of data; generating converted data obtained by converting the correspondence of each of the plurality of data on the basis of the generated common conversion information and the generated individual conversion information; and updating the collation data and the learner on the basis of the generated converted data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a learning method according to an embodiment;

FIG. 2 is an explanatory diagram illustrating an example of a classification system;

FIG. 3 is a block diagram illustrating a hardware configuration example of an information processing device;

FIG. 4 is an explanatory diagram illustrating an example of input data,

FIG. 5 is an explanatory diagram illustrating an example of collation data,

FIG. 6 is an explanatory diagram illustrating an example of common conversion information;

FIG. 7 is an explanatory diagram illustrating an example of individual conversion information;

FIG. 8 is a diagram illustrating an example of a neural network;

FIG. 9 is a block diagram illustrating a functional configuration example of an information processing device;

FIG. 10 is an explanatory diagram illustrating a flow of an operation example 1 of the information processing device;

FIG. 11 is an explanatory diagram (No, 1) illustrating a specific example of the operation example 1 of the information processing device;

FIG. 12 is an explanatory diagram (No, 2) illustrating a specific example of the operation example 1 of the information processing device;

FIG. 13 is a flowchart illustrating an example of an overall processing procedure according to the operation example 1;

FIG. 14 is an explanatory diagram (No. 1) illustrating a flow f an operation example 2 of the information processing device;

FIG. 15 is an explanatory diagram (No. 2) illustrating the flow of the operation example 2 of the information processing device;

FIG. 16 is an explanatory diagram (No. 1) illustrating a specific example of the operation example 2 of the information processing device;

FIG. 17 is an explanatory diagram (No. 2) illustrating a specific example of the operation example 2 of the information processing device; and

FIG. 18 is a flowchart illustrating an example of an overall processing procedure according to the operation example 2.

### DESCRIPTION OF EMBODIMENTS

However, with the prior art, improvement of learning accuracy of machine learning is difficult. For example, when determining the correspondence between a node and an input value, the neural network and the collation data may not be able to be accurately updated unless the input value is related to what item is taken into consideration.

In one aspect, the present embodiment aims to improve the learning accuracy of machine learning.

Hereinafter, an embodiment of a machine-learning program (may be referred to as “learning program”, “machine learning program”, and the like), a machine-learning method (may be referred to as “learning method”, “machine learning method”, and the like), and an information processing device according to the present embodiment will be described with reference to the drawings.

### Example of Learning Method According to Embodiment

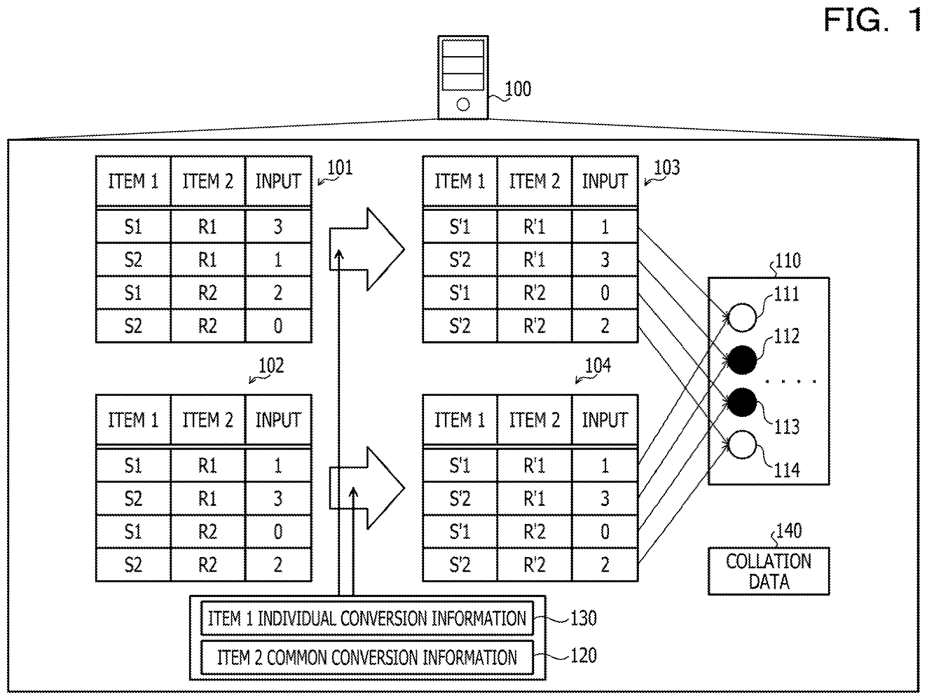

FIG. 1 is an explanatory diagram illustrating an example of a learning method according to an embodiment. An information processing device 100 is a computer that implements machine learning using a learner. The information processing device 100 is, for example, a server, a personal computer (PC), or the like. The learner is, for example, a neural network.

The neural network includes an input layer, an intermediate layer, and an output layer. The neural network may include a plurality of intermediate layers. Each layer of the input layer, the intermediate layer, and the output layer has one or more nodes. The node executes predetermined processing for a value input to its own node, and outputs a value obtained by the predetermined processing.

The neural network is used for classifying input data, for example. The input data includes a plurality of combinations, each combination being of an item value of each item of one or more items and an input value. The neural network expresses a result of classifying the input data as an output value of an output layer in response to an input of the input value included in the input data to a node of the input layer.

In the past, in machine learning using a neural network, learning of the neural network has been performed using learning data in which input data is associated with teaching data indicating a correct classification result of the input data. For example, an information processing device inputs the input data to the neural network, and calculates an input error by error back propagation from an output error obtained by comparing output data from the neural network with the teaching data. Then, the information processing device learns the neural network on the basis of the input error, thereby improving the accuracy of the neural network.

However, in the past, it may be difficult to perform learning of the neural network with high accuracy. For example, a correspondence between each of a plurality of input values included in the input data and each of a plurality of nodes in an input layer of the neural network is not considered, and learning of the neural network may not be able to be accurately performed.

For example, there may be a case where a relation with a person or an object indicated by one or more item values included in the input data affects the accuracy of classifying the input data. In this case, it is favorable to perform learning of the neural network in consideration of the relation with a person or an object. In the past, learning of the neural network has not been able to be accurately performed because what kind of relation with a person or an object an input value is related is not considered, and the correspondence between the input value and a node is not adjusted.

In contrast, a technique of learning of the neural network using collation data, in addition to the learning data, is conceivable. The collation data is data for indicating a criterion of converting a correspondence between each of a plurality of nodes of an input layer of the neural network and each of a plurality of input values included in input data so as to improve the accuracy of classifying the input data.

For example, in the above technique, converted data obtained by converting the correspondence of each of the plurality of input values included in the input data with each of the plurality of nodes of the input layer of the neural network on the basis of the collation data. Next, in the above technique, each of the plurality of input values included in the converted data is input to each of the plurality of nodes of the input layer of the neural network. Then, in the above technique, an input error is calculated by error back propagation from an output error obtained by comparing output data of the neural network with teaching data, and learning of the neural network is performed on the basis of the input error and the collation data is learned, so that the accuracy of the collation data is improved.

Here, even with the above technique, it may be difficult to accurately perform learning of the neural network and the collation data. For example, when converting the correspondence between an input value and a node, which item value the input value is related may not be considered, and learning of the neural network and the collation data may not be able to be accurately performed.

For example, there may be a case where a person or an object itself indicated by an item value affects the accuracy of classifying the input data, in addition to the relation with a person or an object. In this case, it is favorable to learn the neural network and the collation data in consideration of the person or the object itself in addition to the relation with the person or the object. In the above technique, the correspondence between an input value and a node is converted without considering which person or object the input value is related. In this case, the correspondence between an input value and a node can vary for each input data, and thus the viewpoint of which item value the input value in the input data is related is not considered in the learning. Therefore, learning of the neural network and the collation data is not able to be accurately performed.

As an example, a case of performing learning of a neural network for classifying input data obtained from a communication log of a network in a fixed period to whether having unauthorized communication is conceivable. The input data includes, for example, a transmission source address and a transmission destination address as item values, and includes a communication amount as an input value.

In this case, whether the input value is related to a specific transmission destination address may affect the accuracy of classifying the input data to whether having unauthorized communication. Therefore, it is favorable to convert the correspondence between the input value and a node so that the input value related to the specific transmission destination address is input to a specific node included in the input layer of the neural network. Meanwhile, learning of the neural network and the collation data is not able to be accurately performed unless whether the input value is related to the specific transmission destination address is considered.

Therefore, in the present embodiment, a learning method capable of performing learning of the neural network and the collation data in consideration of a person or an object itself indicated by some item value in addition to the relation with a person or an object indicated by one or more item values included in the input data will be described.

In FIG. 1, the information processing device 100 updates a learner 110. The learner 110 has an input node. The learner 110 is, for example, a neural network. The input node is a node of the input layer of the neural network.

(1-1) The information processing device 100 generates common conversion information 120 commonly applied to a plurality of data in association with one or more items among a plurality of items. The data is input data input to the learner 110. The data includes a plurality of combinations, each combination being of an item value of each item of the plurality of items and an input value.

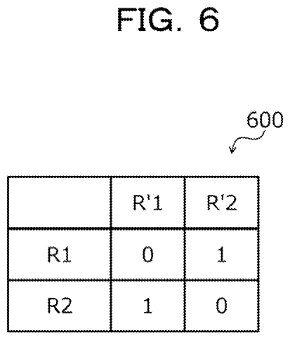

The common conversion information 120 is information for converting a correspondence between each of the input values in the data and each of input nodes in the learner 110 in the case of the data is input to the learner 110. An example of the common conversion information 120 will be described below with reference to FIG. 6, for example. In the example of FIG. 1, the information processing device 100 generates the common conversion information 120 commonly applied to data 101 and 102 in association with an item 2.

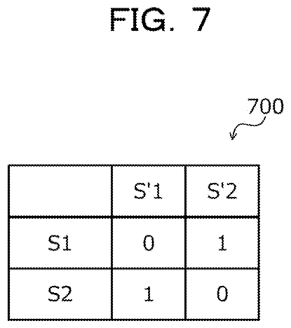

(1-2) The information processing device 100 generates individual conversion information 130 individually applied to each data in association with remaining items excluding one or more items of the plurality of items. The individual conversion information 130 is information for converting a correspondence between each of the input values in the data and each of input nodes in the learner 110 in the case of the data is input to the learner 110. An example of the individual conversion information 130 will be described below with reference to FIG. 7, for example.

The information processing device 100 generates individual conversion information 130 on the basis of a similarity between the test data and the collation data obtained by converting the correspondence of each data of the plurality of data, for example. In the example of FIG. 1, the information processing device 100 generates the individual conversion information 130 individually applied to the data 101 and 102 in association with an item 1.

(1-3) The information processing device 100 generates converted data obtained by converting a correspondence of each data of the plurality of data on the basis of the generated common conversion information 120 and individual conversion information 130. In the example of FIG. 1, the information processing device 100 generates converted data 103 and 104 from the data 101 and 102.

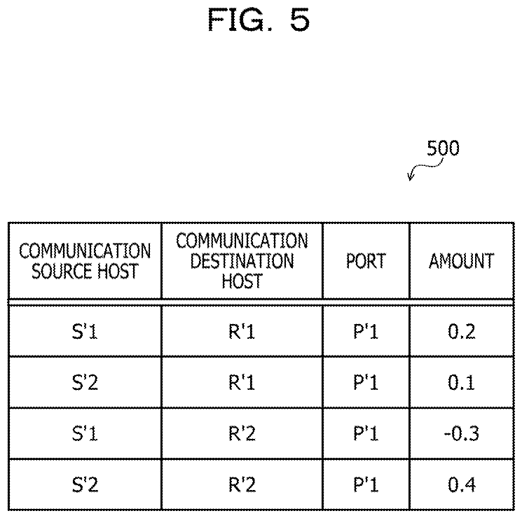

(1-4) The information processing device 100 updates collation data 140 and the learner 110 on the basis of the generated converted data. An example of the collation data 140 will be described below with reference to FIG. 5, for example. In the example of FIG. 1, the information processing device 100 inputs the generated converted data 103 and 104 to the learner 110, calculates an input error by error back propagation, and updates the collation data 140 and the learner 110 on the basis of the input error.

Thereby, the information processing device 100 may improve the learning accuracy. The information processing device 100 can update the collation data 140 and the learner 110 in consideration of, for example, a person or an object itself indicated by an item value.

For example, the information processing device 100 can associate the input value of an item value “R1” of the item 2 with either an input node 111 or 112 commonly in relation to the data 101 and 102 according to the common conversion information 120. Furthermore, similarly, the information processing device 100 can associate the input value of an item value “R2” of the item 2 with either an input node 113 or 114. Therefore, the information processing device 100 can update the collation data 140 and the learner 110 in consideration of the item value of the item 2.

As a result, the information processing device 100 can improve the learning accuracy and obtain the highly accurate collation data 140 and learner 110. Then, the information processing device 100 can make the obtained collation data 140 and learner 110 available for classifying data to be classified. Furthermore, the information processing device 100 may improve the accuracy of classifying the data to be classified, using the collation data 140 and the learner 110.

### Example of Classification System 200

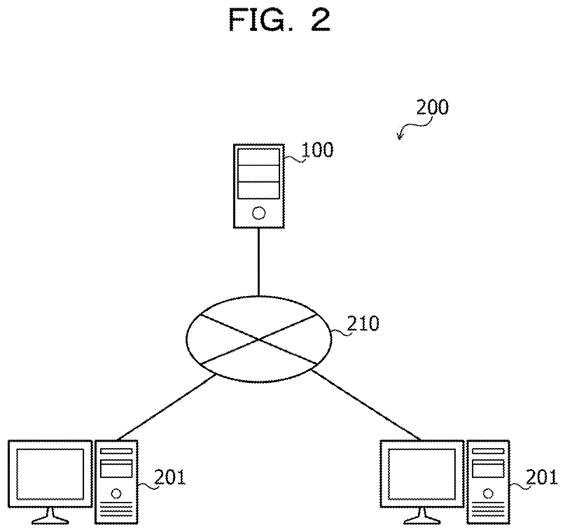

Next, an example of a classification system 200 to which the information processing device 100 illustrated in FIG. 1 is applied will be described with reference to FIG. 2.

FIG. 2 is an explanatory diagram illustrating an example of the classification system 200. In FIG. 2, the classification system 200 includes the information processing device 100 and one or more client devices 201.

In the classification system 200, the information processing device 100 and the client device 201 are connected via a wired or wireless network 210. Examples of the network 210 include a local area network (LAN), a wide area network (WAN), the Internet, or the like.

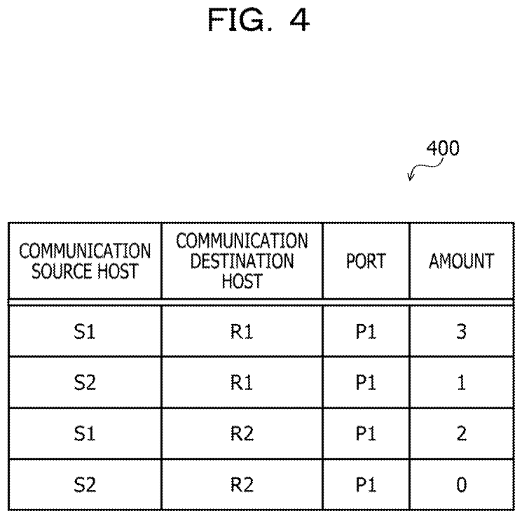

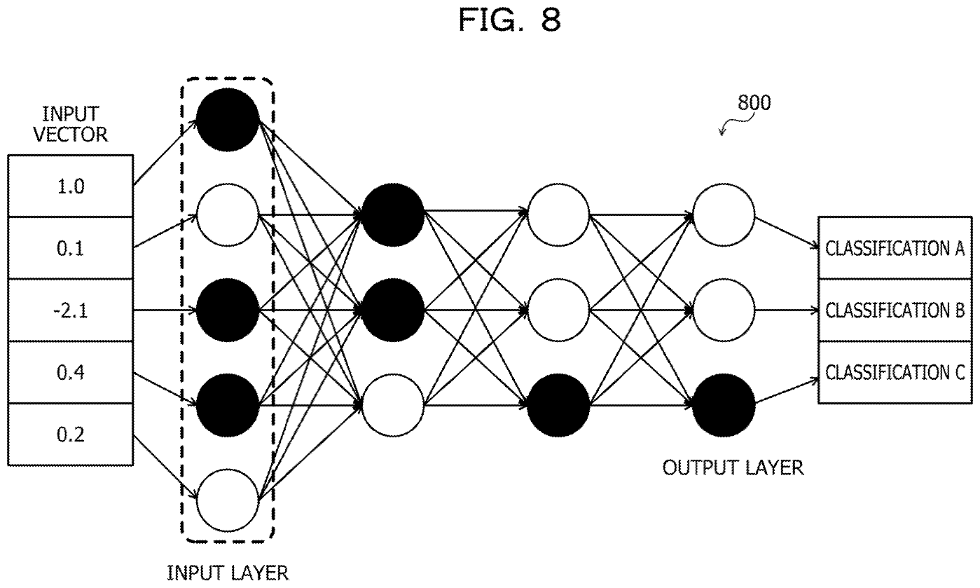

The information processing device 100 is a computer including the collation data and the neural network. An example of the collation data will be described below with reference to, for example, FIG. 5. An example of the neural network will be described below with reference to, for example, FIG. 8. The information processing device 100 receives the learning data including the input data or the input data to be classified from the client device 201. An example of the input data will be described below with reference to, for example, FIG. 4.

The information processing device 100 generates the common conversion information and the individual conversion information on the basis of the learning data, and updates the neural network and the collation data. An example of the common conversion information will be described below with reference to, for example, FIG. 6. An example of the individual conversion information will be described below with reference to, for example, FIG. 7.

The information processing device 100 classifies the input data to be classified on the basis of the updated neural network and collation data. The client device 201 is a computer that transmits the learning data including the input data or the input data to be classified to the information processing device 100. The client device 201 may receive a classification result of the input data to be classified.

### Use Example of Classification System 200 (No. 1)

For example, the information processing device 100 may use statistical data of a communication log of a network within a fixed period as input data. The information processing device 100 generates a neural network and collation data for classifying input data with a fraudulent activity and input data without a fraudulent activity on the basis of learning data including input data. The fraudulent activity includes, for example, a DDoS attack, a targeted attack, or the like. Furthermore, the information processing device 100 classifies the input data to be classified on the basis of the updated neural network and collation data.

### Use Example of Classification System 200 (No. 2)

For example, the information processing device 100 may use statistical data of a transaction log of a financial institution within a fixed period as input data. The information processing device 100 generates a neural network and collation data for classifying input data with a fraudulent activity and input data without a fraudulent activity on the basis of learning data including input data. The fraudulent activity includes, for example, wire transfer fraud, money laundering, or the like. Furthermore, the information processing device 100 classifies the input data to be classified on the basis of the updated neural network and collation data.

Here, the case in which the information processing device 100 receives the learning data including the input data or the input data to be classified from the client device 201 has been described. However, an embodiment is not limited to the case. For example, the information processing device 100 may accept the learning data including the input data and the like on the basis of a user's operation input. Furthermore, the information processing device 100 may acquire the learning data including the input data and the like from a connected recording medium. The following description will be given using the above-described use example (No, 1) of the classification system 200 as an example.

### Hardware Configuration Example of Information Processing Device 100

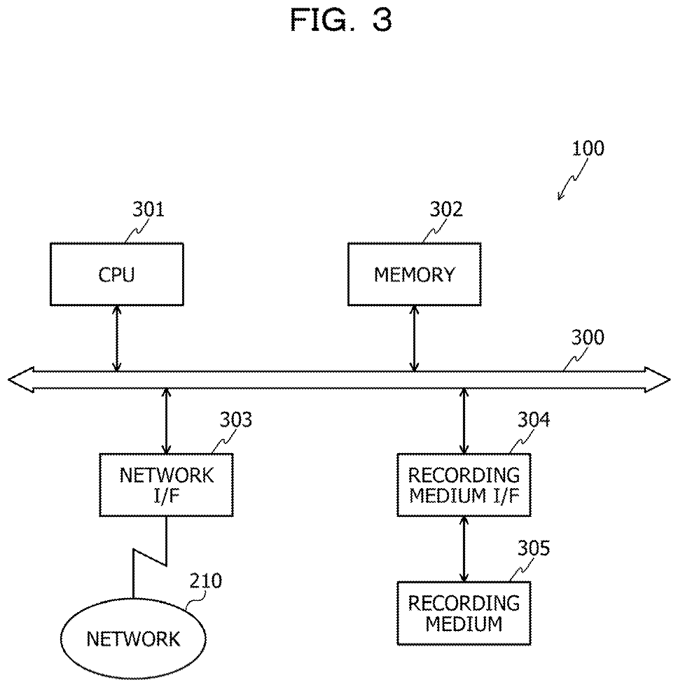

Next, a hardware configuration example of the information processing device 100 will be described with reference to FIG. 3,

FIG. 3 is a block diagram illustrating a hardware configuration example of the information processing device 100. In FIG. 3, the information processing device 100 includes a central processing unit (CPU) 301, a memory 302, a network interface (I/F) 303, a recording medium I/F 304, and a recording medium 305. Furthermore, each of these components is respectively connected to one another by a bus 300.

Here, the CPU 301 performs overall control of the information processing device 100. The memory 302 includes, for example, a read only memory (ROM), a random access memory (RAM), a flash ROM, or the like. For example, for example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is connected to the network 210 through a communication line, and is connected to another computer through the network 210. Then, the network I/F 303 manages an interface between an inside of the information processing device 100 and the network 210, and controls input and output of data to and from another computer. The network I/F 303 is, for example, a modem, a LAN adapter, or the like.

The recording medium I/F 304 controls read/write of data to/from the recording medium 305 under the control of the CPU 301, The recording medium I/F 304 is, for example, a disk drive, a solid state drive (SSD), a universal serial bus (USB) port, or the like. The recording medium 305 is a nonvolatile memory that stores data written under the control of the recording medium IA′ 304. The recording medium 305 is, for example, a disk, a semiconductor memory, a USB memory, or the like. The recording medium 305 may be attachable to and detachable from the information processing device 100.

The information processing device 100 may further include, for example, a keyboard, a mouse, a display, a printer, a scanner, a microphone, a speaker, or the like in addition to the above-described components. Furthermore, the information processing device 100 may include a plurality of the recording media I/F 304 and the recording media 305. Furthermore, the information processing device 100 may not include the recording medium I/F 304 and the recording medium 305.

### Example of Input Data 400

Next, an example of input data 400 will be described with reference to FIG. 4.

FIG. 4 is an explanatory diagram illustrating an example of the input data 400. In FIG. 4, the input data 400 has fields for communication source host, communication destination host, port, and amount. In the field for communication source host, an address indicating a communication source host is set. In the field for communication destination host, an address indicating a communication destination host is set. In the field for port, a number indicating a port used for communication is set. In the field for amount, a communication amount from the communication source host to the communication destination host via the port in a communication log in a fixed period is set. The communication amount set for each record of the input data 400 is associated with any of nodes of an input layer of a neural network 800 as an input value according to the position of each record.

### Example of Collation Data 500

Next, an example of collation data 500 will be described with reference to FIG. 5.

FIG. 5 is an explanatory diagram illustrating an example of the collation data 500. In FIG. 5, the collation data 500 has fields for communication source host, communication destination host, port, and amount. Since each field is similar to each field of the input data 400, description thereof is omitted. The communication amount set for each record of the collation data 500 is associated with any of the nodes of the input layer of the neural network 800 as an input value according to the position of each record. The collation data 500 indicates a criterion as to how it is favorable to convert the correspondence between a node of the input layer of the neural network 800 and an input value by changing the positions of each records of the input data 400.

### Example of Common Conversion Information 600

Next, an example of common conversion information 600 will be described with reference to FIG. 6.

FIG. 6 is an explanatory diagram illustrating an example of the common conversion information 600. In FIG. 6, the common conversion information 600 indicates a criterion regarding any of items of when the input data 400 is converted according to the collation data 500. In the following description, such an item may be referred to as a “common item”. In the example of FIG. 6, a row of the common conversion information 600 corresponds to an item value of the common item of the input data 400. A column of the common conversion information 600 corresponds to an item value of the common item of the collation data 500. A numerical value “1” represents the correspondence between the input data 400 and the collation data 500. Thereby, the common conversion information 600 expresses converting the input data 400 such that the item value of the common item of the input data 400 corresponds to the position of the item value of the common item of the collation data 500,

### Example of Individual Conversion Information 700

Next, an example of individual conversion information 700 wily be described with reference to FIG. 7.

FIG. 7 is an explanatory diagram illustrating an example of the individual conversion information 700. In FIG. 7, the individual conversion information 700 indicates a criterion regarding any of items of when the input data 400 is converted according to the collation data 500. In the following description, such an item may be referred to as an “individual item”. In the example of FIG. 7, a row of the individual conversion information 700 corresponds to an item value of the individual item of the input data 400. A column of the individual conversion information 700 corresponds to an item value of the individual item of the collation data 500. A numerical value “1” represents the correspondence between the input data 400 and the collation data 500. Thereby, the individual conversion information 700 expresses converting the input data 400 such that the item value of the individual item of the input data 400 corresponds to the position of the item value of the individual item of the collation data 500.

### Example of Neural Network 800

Next, an example of the neural network 800 will be described with reference to FIG. 8.

FIG. 8 is a diagram illustrating an example of the neural network 800. In FIG. 8, the neural network 800 includes an input layer, two intermediate layers, and an output layer. An input vector is a vector in which the input values of the input data 400 are arranged. The input vector is input to the input layer. The neural network 800 executes processing specified in the nodes of the input layer, the intermediate layers, and the output layer, in response to the input of the input vector to the input layer, and outputs output data in which output values of the output layer are arranged. The output data indicates a classification result.

### Hardware Configuration Example of Client Device 201

Since the hardware configuration example of the client device 201 is similar to the hardware configuration example of the information processing device 100 illustrated in FIG. 3, the description thereof is omitted.

### Functional Configuration Example of Information Processing Device 100

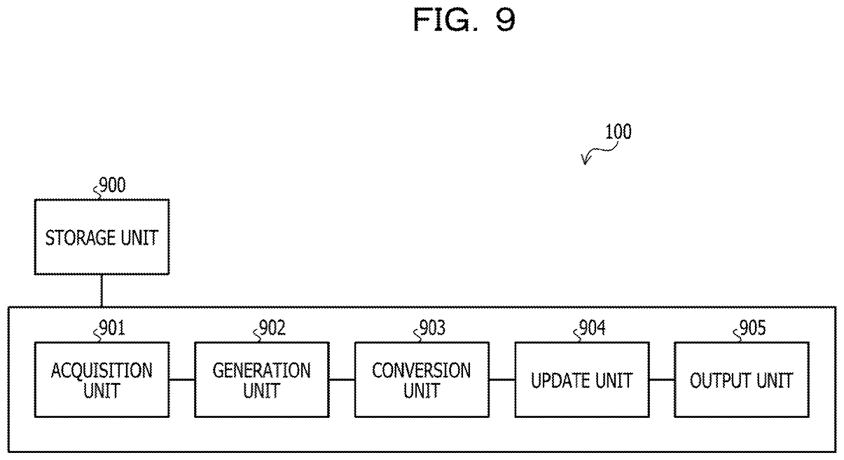

Next, a functional configuration example of the information processing device 100 will be described with reference to FIG. 9.

FIG. 9 is a block diagram illustrating a functional configuration example of the information processing device 100. The information processing device 100 includes a storage unit 900, an acquisition unit 901, a generation unit 902, a conversion unit 903, an update unit 904, and an output unit 905.

The storage unit 900 is implemented by, for example, a storage area of the memory 302, the recording medium 305 illustrated in FIG. 3, or the like. Hereinafter, the case in which the storage unit 900 is included in the information processing device 100 will be described. However, the embodiment is not limited to the case. For example, the storage unit 900 may be included in a device different from the information processing device 100, and stored contents of the storage unit 900 may be able to be referred to by the information processing device 100.

The acquisition unit 901 to the output unit 905 function as an example of a control unit. For example, for example, the acquisition unit 901 to the output unit 905 implement functions thereof by causing the CPU 301 to execute a program stored in the storage area of the memory 302, the recording medium 305, or the like illustrated in FIG. 3 or by the network I/F 303. A processing result of each functional unit is stored in, for example, the storage area of the memory 302, the recording medium 305, or the like illustrated in FIG. 3.

The storage unit 900 stores various types of information referred to or updated in the processing of each functional unit. The storage unit 900 stores, for example, the input data 400. The input data 400 includes a plurality of combinations, each combination being of an item value of each item of a plurality of items and an input value. The storage unit 900 stores, for example, the collation data 500. The storage unit 900 stores, for example, the common conversion information 600 and the individual conversion information 700. The common conversion information 600 and the individual conversion information 700 are information for converting the correspondence between each of the input values in the input data 400 and each of the nodes of the input layer in the neural network 800. The common conversion information 600 is commonly applied to a plurality of the input data 400. The individual conversion information 700 is individually applied to the input data 400. The storage unit 900 stores, for example, a learner. The learner is the neural network 800. In the following description, the case where the learner is the “neural network 800” will be described.

The acquisition unit 901 acquires various types of information to be used for the processing of each functional unit. The acquisition unit 901 stores the acquired various types of information in the storage unit 900 or outputs the acquired various types of information to each function unit. Furthermore, the acquisition unit 901 may output the various types of information stored in the storage unit 900 to each function unit. The acquisition unit 901 acquires the various types of information on the basis of, for example, the user's operation input. The acquisition unit 901 may receive the various types of information from a device different from the information processing device 100, for example.

For example, the acquisition unit 901 acquires learning data in which the input data 400 and teaching data indicating a correct classification result of the input data 400 are associated with each other. Thereby, the acquisition unit 901 can update the neural network 800 and the collation data 500. For example, the acquisition unit 901 may acquire the input data 400 to be classified after updating the neural network 800 and the collation data 500. Thereby, the acquisition unit 901 can make the neural network 800 available.

The generation unit 902 generates the common conversion information 600 in association with one or more items of the plurality of items. The one or more items are the common items. The common items are preset by the user. The generation unit 902 calculates, for example, a similarity between test data and the collation data 500 obtained by converting the correspondence of each of the input data 400 of the plurality of input data 400. The similarity is expressed by an inner product of a first vector in which input values in the test data are arranged and a second vector in which the input values in the collation data 500 are arranged. The similarity is, for example, a cosine similarity. Then, the generation unit 902 generates the common conversion information 600 on the basis of the similarity, for example. For example, the generation unit 902 generates the common conversion information 600 such that an average value of the similarity is maximized. Thereby, the generation unit 902 can appropriately generate the common conversion information 600.

Here, the update unit 904 may update the common conversion information 600 as will be described below. In this case, the generation unit 902 may generate random common conversion information 600, for example. Thereby, the generation unit 902 can make the common conversion information 600 independent of the collation data 500. Therefore, the generation unit 902 can suppress an increase in the processing amount in the case where the collation data 500 is changed.

The generation unit 902 generates the individual conversion information 700 individually applied to each input data 400 in association with remaining items excluding one or more items of the plurality of items. The remaining items are the individual items. The individual items are preset by the user. The generation unit 902 calculates, for example, a similarity between test data and the collation data 500 obtained by converting the correspondence of each of the input data 400 of the plurality of input data 400. Then, the generation unit 902 generates the individual conversion information 700 on the basis of the similarity, for example. For example, the generation unit 902 generates the individual conversion information 700 such that an average value of the similarity is maximized. Thereby, the generation unit 902 can appropriately generate the individual conversion information 700.

The conversion unit 903 generates converted data obtained by converting the correspondence of each input data 400 of the plurality of input data 400 on the basis of the generated common conversion information 600 and individual conversion information 700. For example, the conversion unit 903 changes the positions of each records of the input data 400 such that a record having a specific item value of the input data 400 matches the position of a record of a specific item value of the collation data 500 indicated by the common conversion information 600 and the individual conversion information 700. Thereby, the conversion unit 903 can obtain the converted data estimated to have a minimum classification error at present and to be used for updating the collation data 500 and the neural network 800.

The update unit 904 updates the collation data 500 and the neural network 800 on the basis of the generated converted data. The update unit 904 calculates, for each input data 400, by error back propagation, an error vector in which errors of the input values in the converted data in the case of inputting the converted data generated from the input data 400 to the neural network 800 are arranged, for example. Furthermore, the update unit 904 calculates a difference in the input value between the converted data generated from the input data 400 and another converted data generated from the input data 400 in the case of changing the common conversion information 600 or the collation data 500, for each input data 400, for example. Next, the update unit 904 calculates a variation vector in which the calculated differences are arranged, for each input data 400, for example. Then, the update unit 904 updates the collation data 500 and the neural network 800 on the basis of the error vector and the variation vector, for example. Thereby, the update unit 904 may improve the accuracy of the collation data 500 and the neural network 800 and improve the learning efficiency.

Furthermore, the update unit 904 may further update the common conversion information 600 on the basis of the generated converted data. The update unit 904 further updates the common conversion information 600 on the basis of the error vector and the variation vector, for example. Thereby, the update unit 904 can obtain the common conversion information 600 with accuracy even when the common conversion information 600 is made independent of the collation data 500.

### After Updating Neural Network 800 and Collation Data 500

Here, a case in which the acquisition unit 901 acquires the input data 400 to be classified after updating the neural network 800 and the collation data 500 will be described.

In this case, the conversion unit 903 generates converted data obtained by converting the correspondence of the input data 400 to be classified on the basis of the generated common conversion information 600 and the updated collation data 500, and inputs the converted data to the updated neural network 800. The conversion unit 903 generates the converted data obtained by converting the correspondence of the input data 400 to be classified to maximize the similarity between the converted data and the collation data 500 according to the common conversion information 600, and inputs the converted data to the updated neural network 800, for example.

The output unit 905 classifies the input data 400 to be classified on the basis of the output data output from the neural network 800 in response to the input of the converted data to the neural network 800. The output unit 905 outputs the result of classifying the input data 400 to be classified. An output format is, for example, display on a display, print output to a printer, transmission to an external device by the network I/F 303, or storage to the storage area of the memory 302, the recording medium 305, or the like. Thereby, the output unit 905 can enable the user to grasp the result of classifying the input data 400 to be classified.

### Operation Example 1 of Information Processing Device 100

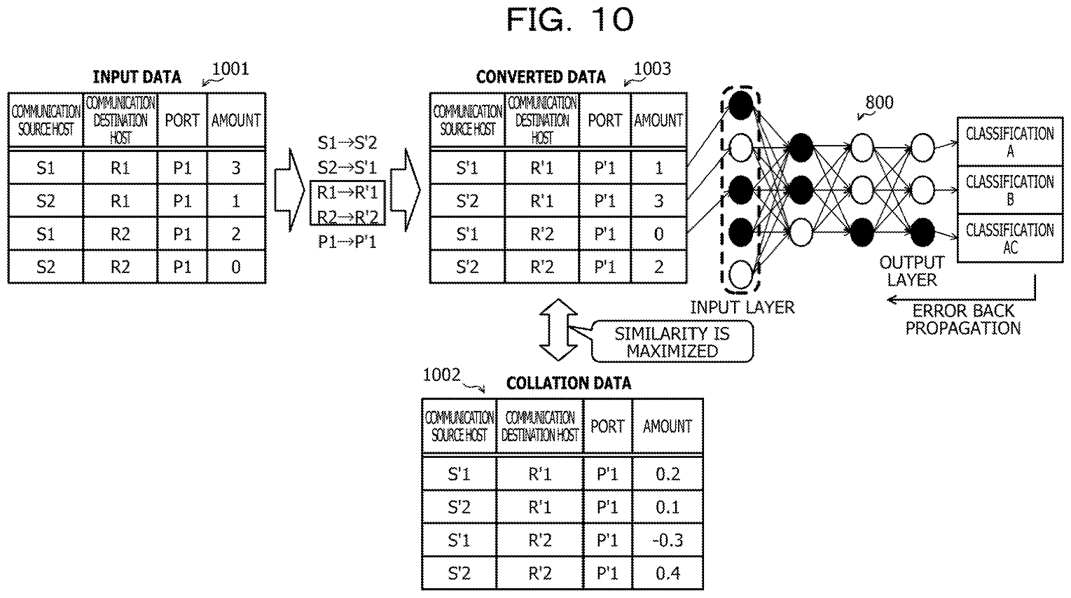

Next, an operation example 1 of the information processing device 100 will be described with reference to FIGS. 10 to 12. First, a flow of the operation example 1 of the information processing device 100 will be described with reference to FIG. 10.

FIG. 10 is an explanatory diagram illustrating a flow of the operation example 1 of the information processing device 100. In FIG. 10, (10-1) the information processing device 100 acquires a learning data group. The learning data includes input data 1001. The information processing device 100 includes collation data 1002.

(10-2) The information processing device 100 generates common conversion information and individual conversion information for generating converted data 1003 by converting the order of records of the input data 1001 included in each learning data of the learning data group. The information processing device 100 generates the common conversion information and the individual conversion information to maximize an average value of the similarity of the converted data 1003 generated regarding the learning data group with the collation data 1002, for example.

For example, the information processing device 100 experimentally rearranges the records of the input data 1001, and generates converted data for search for searching for a rearrangement pattern of rearranging the records of the input data 1001. Next, for example, the information processing device 100 calculates an inner product of a first vector in which the amounts in the converted data for search are arranged in order, and a second vector in which the amounts in the collation data 1002 are arranged in order, as the similarity of the converted data for search with the collation data 1002, for each converted data for search. Then, for example, the information processing device 100 calculates the average value of the similarity obtained from the calculated inner product, searches for the rearrangement pattern in which the average value of the similarity is maximized, and generates the common conversion information and the individual conversion information indicating the searched rearrangement pattern.

(10-3) The information processing device 100 generates the converted data 1003 by converting the order of the records of the input data 1001 on the basis of the generated common conversion information and individual conversion information. At this time, the information processing device 100 converts the order of the records such that positions of an item value “R1” and an item value “R2” respectively match positions of an item value “R′1” and an item value “R2” of the collation data 1002, commonly in all the input data 1001, for example. Furthermore, the information processing device 100 converts the order of the records such that positions of an item value “S1” and an item value “S2” match either the position of an item value “S′1” or an item value “S2” of the collation data 1002, individually in the input data 1001, for example.

(10-4) The information processing device 100 updates the neural network 800 and the collation data 1002 on the basis of a result of inputting the converted data 1003 to the neural network 800, for each converted data 1003. The information processing device 100 calculates an input error by error back propagation on the basis of the result of inputting the converted data 1003 to the neural network 800, for example. Then, the information processing device 100 updates the neural network 800 and the collation data 1002 on the basis of the input error, for example.

Thereby, the information processing device 100 may improve the learning accuracy of machine learning. The information processing device 100 can convert the order of the records such that the positions of the item value “R1.” and the item value “R2” respectively match the positions of the item value “R′1” and the item value “R′2” of the collation data 1002, commonly in all the input data 1001, for example. Therefore, in a case where the communication destination host affects the classification accuracy by the neural network 800, the information processing device 100 can easily perform learning of the highly accurate neural network 800 and collation data 1002.

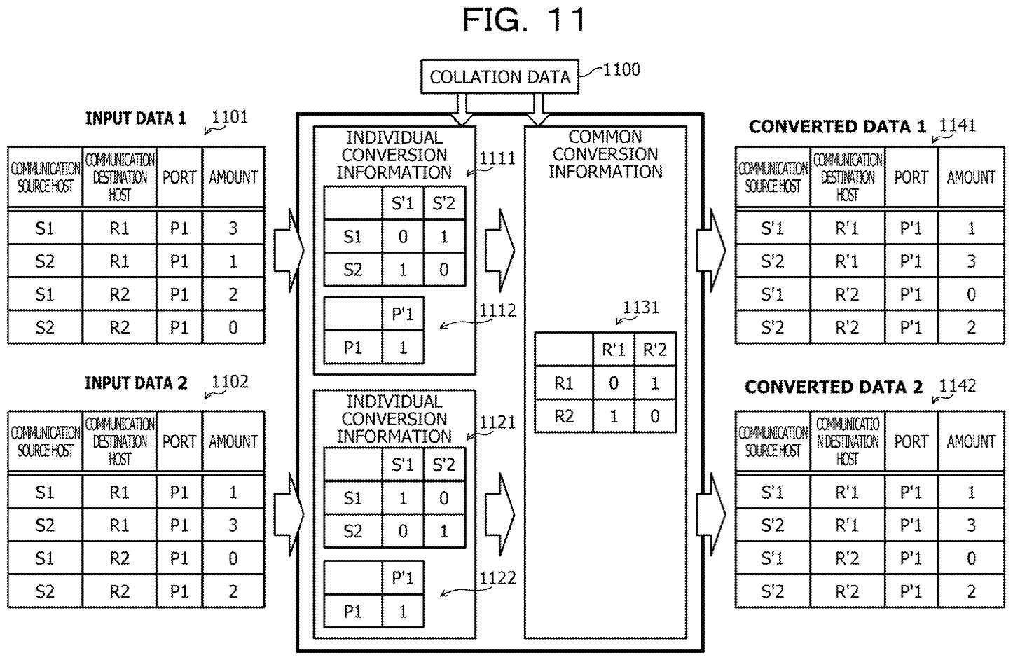

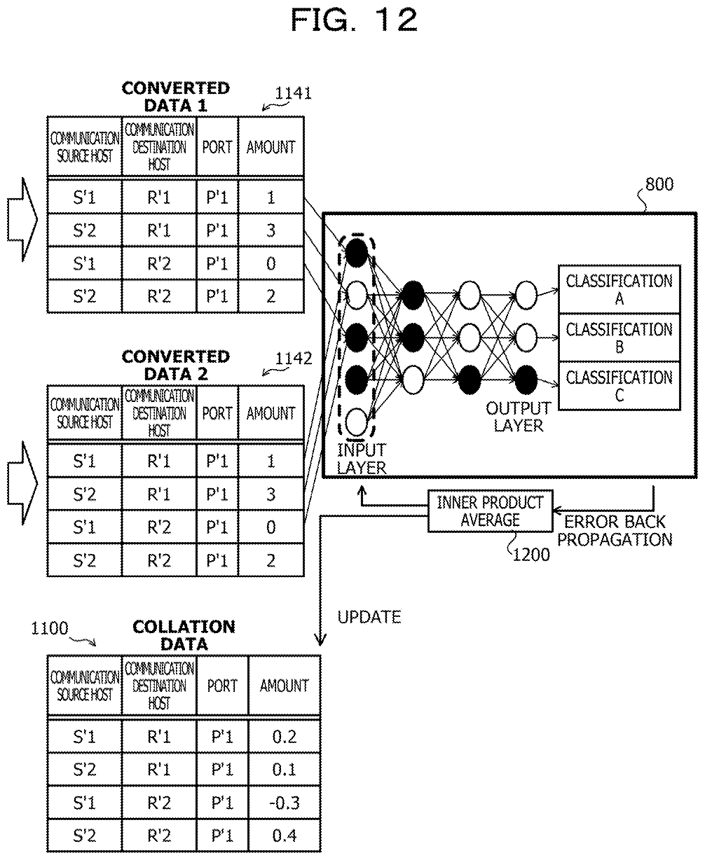

FIGS. 11 and 12 are explanatory diagrams illustrating specific examples of the operation example 1 of the information processing device 100. In FIG. 11, (11-1) the information processing device 100 includes collation data 1100. The information processing device 100 acquires learning data including input data 1101 and learning data including input data 1102.

(11-2) The information processing device 100 experimentally rearranges the records of the input data 1101 and 1102, and generates the converted data for search for searching for the rearrangement pattern of rearranging the records of the input data 1101 and 1102. Next, for example, the information processing device 100 calculates the inner product of the first vector in which the amounts in the converted data for search are arranged in order, and the second vector in which the amounts in the collation data 1100 are arranged in order, as the similarity of the converted data for search with the collation data 1100, for each converted data for search.

Then, for example, the information processing device 100 calculates the average value of the similarity obtained from the calculated inner product, searches for the rearrangement pattern in which the average value of the similarity is maximized, and generates common conversion information 1131 indicating the searched rearrangement pattern. Furthermore, the information processing device 100 generates individual conversion information 1111 and 1112 indicating the rearrangement pattern in which the similarity is maximized under the common conversion information 1131, for the input data 1101.

Furthermore, the information processing device 100 generates individual conversion information 1121 and 1122 indicating the rearrangement pattern in which the similarity is maximized under the common conversion information 1131, for the input data 1102.

(11-3) The information processing device 100 generates converted data 1141 by converting the order of the records of the input data 1101 on the basis of the common conversion information 1131 and the individual conversion information 1111 and 1112. Furthermore, the information processing device 100 generates converted data 1142 by converting the order of the records of the input data 1102 on the basis of the common conversion information 1131 and the individual conversion information 1121 and 1122. Next, description of FIG. 12 will be made.

In FIG. 12, (12-1) the information processing device 100 inputs the converted data 1141 to the nodes of the input layer of the neural network 800. Next, the information processing device 100 calculates a difference between an output vector in which output values of the nodes of the output layer of the neural network 800 are arranged and an output vector in which output values in the teaching data are arranged as an output error. Then, the information processing device 100 calculates an input error by error back propagation on the basis of the output error, and calculates an error vector for the converted data 1141 in which the input errors are arranged in order. Similarly, the information processing device 100 inputs the converted data 1142 to the nodes of the input layer of the neural network 800, and calculates an error vector for the converted data 1142.

(12-2) The information processing device 100 experimentally changes the first amount of the collation data 1100 by 1 and converts the order of the records of the input data 1101 and 1102 to generate test data for the input data 1101 and 1102. The first amount is the amount of the first record. Then, the information processing device 100 calculates a variation between an input vector in which the amounts of the test data for the input data 1101 are arranged in order and an input vector in which the amounts of the converted data 1141 generated from the input data 1101 are arranged in order. Next, the information processing device 100 calculates a variation vector for the converted data 1141 in which the calculated variations are arranged in order. Then, the information processing device 100 calculates an inner product of the calculated error vector and the variation vector for the converted data 1141. Furthermore, the information processing device 100 similarly calculates an inner product for the converted data 1142.

(12-3) The information processing device 100 calculates an average value 1200 of the inner products for the converted data 1141 and 1142. Here, in a case where the average value 1200 of the inner products is negative, the information processing device 100 determines that a change direction of experimentally changing the first amount of the collation data 1100 is a direction of reducing the output error. On the other hand, in a case where the average value 1200 of the inner products is positive, the information processing device 100 determines that the change direction of experimentally changing the first amount of the collation data 1100 is a direction of expanding the output error. Then, the information processing device 100 changes the first amount of the collation data 1100 on the basis of the determination result. The information processing device 100 similarly changes the second and subsequent amounts of the collation data 1100.

(12-4) The information processing device 100 updates parameters of the neural network 800 on the basis of the output error. Thereby, the information processing device 100 may improve the learning accuracy of machine learning and facilitate learning of the highly accurate neural network 800 and collation data 1100.

Here, the case in which the information processing device 100 generates the individual conversion information 1111 and 1112 and the individual conversion information 1121 and 1122 under the common conversion information 1131 after generating the common conversion information 1131 has been described. However, an embodiment is not limited to the case. For example, there may be a case in which the information processing device 100 collectively generates the common conversion information 1131, the individual conversion information 1111 and 1112, and the individual conversion information 1121 and 1122 on the basis of the rearrangement pattern in which the average value of the similarity obtained from the inner product is maximized.

### Overall Processing Procedure in Operation Example 1

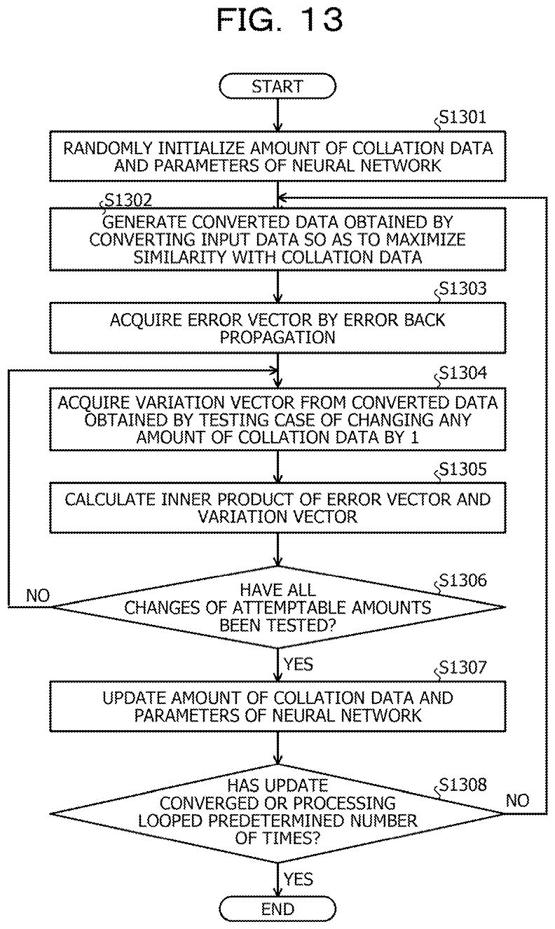

Next, an example of an overall processing procedure executed by the information processing device 100 in the operation example 1 will be described with reference to FIG. 13. The overall processing is implemented by, for example, the CPU 301, the storage area of the memory 302, the recording medium 305, or the like, and the network I/F 303 illustrated in FIG. 3.

FIG. 13 is a flowchart illustrating an example of the overall processing procedure according to the operation example 1. In FIG. 13, the information processing device 100 randomly initializes the amount of the collation data and the parameters of the neural network (step S1301).

Next, the information processing device 100 generates the converted data obtained by converting the input data so as to maximize the similarity with the collation data (step S1302). Then, the information processing device 100 acquires the error vector by error back propagation (step S1303).

Next, the information processing device 100 acquires the variation vector from the converted data obtained by testing the case of changing any amount of the collation data by 1. (step S1304). Then, the information processing device 100 calculates the inner product of the error vector and the variation vector (step S1305).

Next, the information processing device 100 determines whether all of changes in attemptable amounts have been tested in step S1304 (step S1306). Here, in a case where there is a change in an untested amount (step S1306: No), the information processing device 100 returns to the processing of step S1304. On the other hand, in a case where all the changes have been tested (step S1306: Yes), the information processing device 100 proceeds to processing of step S1307.

In step S1307, the information processing device 100 updates the amount of the collation data and the parameters of the neural network on the basis of the calculated inner product (step S1307). Next, the information processing device 100 determines whether the update has converged in step S1307 or whether the series of processing in steps S1301 to S1307 have been looped a predetermined number of times (step S1308). Here, in a case where the update has not converged and the series of processing have not been looped a predetermined number of times (step S1308; No), the information processing device 100 returns to the processing of step S1302.

On the other hand, in a case where the update has converged or the series of processing have been looped a predetermined number of times (step S1308: Yes), the information processing device 100 terminates the entire processing. Thereby, the information processing device 100 may improve the learning efficiency.

### Operation Example 2 of Information Processing Device 100

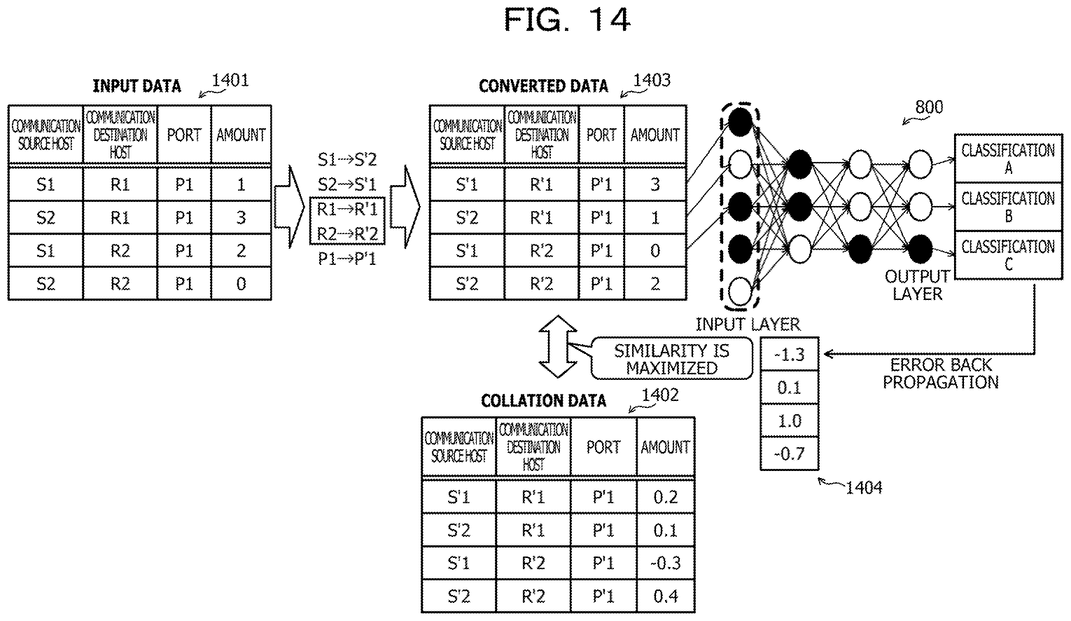

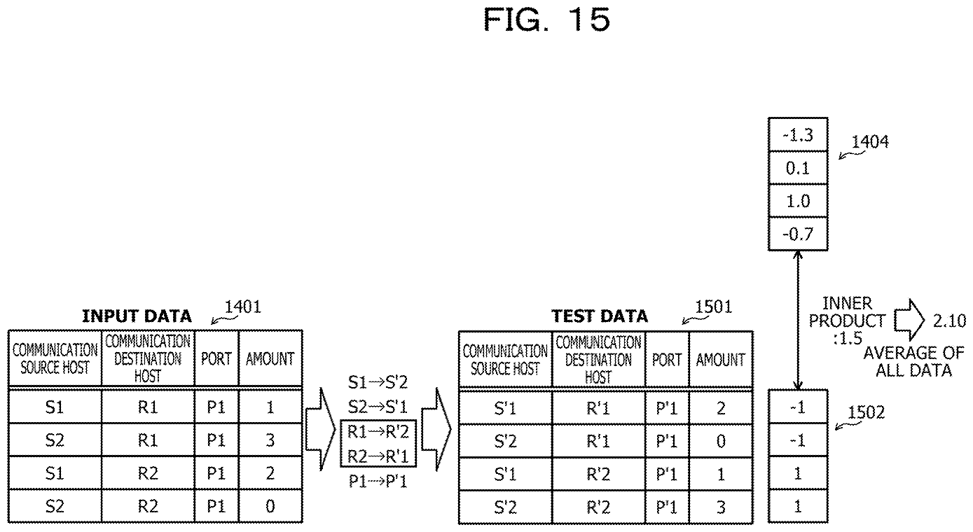

Next, an operation example 2 of the information processing device 100 will be described with reference to FIGS. 14 to 17. First, a flow of the operation example 2 of the information processing device 100 will be described with reference to FIGS. 14 and 15.

FIGS. 14 and 15 are explanatory diagrams illustrating the flow of the operation example 2 of the information processing device 100. In FIG. 14, (14-1) the information processing device 100 acquires a learning data group. The learning data includes input data 1401. The information processing device 100 includes collation data 1402.

(14-2) The information processing device 100 generates common conversion information and individual conversion information for generating converted data 1403 by converting the order of records of the input data 1401 included in each learning data of the learning data group. The information processing device 100 generates, for example, random common conversion information. Furthermore, the information processing device 100 generates the individual conversion information so as to maximize similarity with the collation data 1402, for each converted data 1403 generated for the learning data group, for example.

The information processing device 100 generates the converted data for search for each input data 1401, for experimentally rearranging the records for each input data 1401 and searching for the rearrangement pattern for rearranging the records of the input data 1401. Next, the information processing device 100 calculates the inner product of the first vector in which the amounts in the converted data for search are arranged in order, and the second vector in which the amounts in the collation data 1402 are arranged in order, as the similarity of the converted data for search with the collation data 1402, for each converted data for search. Then, the information processing device 100 searches for the rearrangement pattern in which the similarity obtained from the calculated inner product is maximized, for each input data 1401, and generates the individual conversion information indicating the searched rearrangement pattern.

(14-3) The information processing device 100 generates the converted data 1403 by converting the order of the records of the input data 1401 on the basis of the generated common conversion information and individual conversion information. At this time, the information processing device 100 converts the order of the records such that positions of the item value “R1” and the item value “R2” respectively match positions of the item value “R′1” and the item value “R′2” of the collation data 1402, commonly in all the input data 1401, for example. Furthermore, the information processing device 100 converts the order of the records such that positions of the item value “S1” and the item value “S2” match either the position of the item value “S′1” or the item value “S2” of the collation data 1402, individually in the input data 1401, for example.

(14-4) The information processing device 100 inputs each converted data 1403 to the neural network 800. The information processing device 100 calculates, for each converted data 1403, the difference between the output vector in which the output values of the nodes of the output layer of the neural network 800 are arranged and the output vector in which the output values in the teaching data are arranged as an output error. The information processing device 100 calculates the input error by error back propagation on the basis of the output error for each converted data 1403, and calculates an error vector 1404 in which the input errors are arranged in order. Next, description of FIG. 15 will be given.

In FIG. 15, (15-1) the information processing device 100 experimentally changes the amount of the collation data 1402 by 1 and changes the order of records for each input data 1401, thereby generating test data 1501 for each input data 1401. Then, the information processing device 100 calculates the variation between the input vector in which the amounts in the test data 1501 are arranged in order and the input vector in which the amounts in the converted data 1403 are arranged in order. Next, the information processing device 100 calculates a variation vector 1502 for the converted data 1403 in which the calculated variations are arranged in order. Then, the information processing device 100 calculates the inner product of the error vector 1404 calculated on the basis of the converted data 1403 and the variation vector 1502 calculated on the basis of the converted data 1403, for each converted data 1403.

(15-2) The information processing device 100 calculates the average value of the inner products from the inner product of each converted data 1403. Here, in the case where the inner product is negative, the information processing device 100 determines that the change direction of experimentally changing the amount of the collation data 1402 is the direction of reducing the output error, and changes the amount of the collation data 1402 on the basis of the determined result. Meanwhile, in the case where the inner product is positive, the information processing device 100 determines that the change direction of experimentally changing the amount of the collation data 1402 is the direction of expanding the output error, and changes the amount of the collation data 1402 on the basis of the determined result. The information processing device 100 similarly changes other amounts of the collation data 1402.

(15-3) The information processing device 100 experimentally changes the correspondence indicated by the common conversion information regarding a first common item and converts the order of records for each input data 1401, thereby generating the test data 1501 for each input data 1401. In the example of FIG. 15, the change is made such that the common conversion information regarding the first common item indicates the correspondence of respectively associating the positions of the item value “R1” and the item value “R2” with the positions of the item value “R′2” and the item value “R′1” of the collation data 1402.

Then, the information processing device 100 calculates the variation between the input vector in which the amounts in the test data 1501 are arranged in order and the input vector in which the amounts in the converted data 1403 are arranged in order. Next, the information processing device 100 calculates a variation vector 1502 for the converted data 1403 in which the calculated variations are arranged in order. Then, the information processing device 100 calculates the inner product of the error vector 1404 calculated on the basis of the converted data 1403 and the variation vector 1502 calculated on the basis of the converted data 1403, for each converted data 1403.

(15-4) The information processing device 100 calculates the average value of the inner products from the inner product of each converted data 1403. Here, in the case where the inner product is negative, the information processing device 100 determines that the change direction of experimentally changing the correspondence indicated by the common conversion information regarding the first common item is the direction of reducing the output error. Meanwhile, in the case where the inner product is positive, the information processing device 100 determines that the change direction of experimentally changing the correspondence indicated by the common conversion information regarding the first common item is the direction of expanding the output error. Then, the information processing device 100 changes the correspondence indicated by the common conversion information regarding the first common item on the basis of the determination result.

Here, there may be a plurality of change patterns that change the correspondence indicated by the common conversion information regarding the first common item. In this case, the information processing device 100 may calculate the average value of the inner products for each change pattern, and change the correspondence indicated by the common conversion information regarding the first common item on the basis of a result of comparing the average values of the inner products for the respective change patterns. Furthermore, the information processing device 100 similarly changes the correspondence indicated by the common conversion information regarding another item.

(15-5) The information processing device 100 updates the parameters of the neural network 800 on the basis of the output error. Thereby, the information processing device 100 may improve the learning accuracy of machine learning. In the case where the communication destination host affects the classification accuracy by the neural network 800, for example, the information processing device 100 can easily perform learning of the highly accurate neural network 800 and collation data 1402.

Furthermore, the information processing device 100 can generate and update the common conversion information independently of the collation data 1402. Therefore, the information processing device 100 may suppress an increase in the processing amount in the case of varying the collation data 1402. For example, in a case of implementing machine learning using a mini-batch, the information processing device 100 may suppress an increase in the processing amount needed when updating common conversion information on the basis of only the input data in the mini-batch.

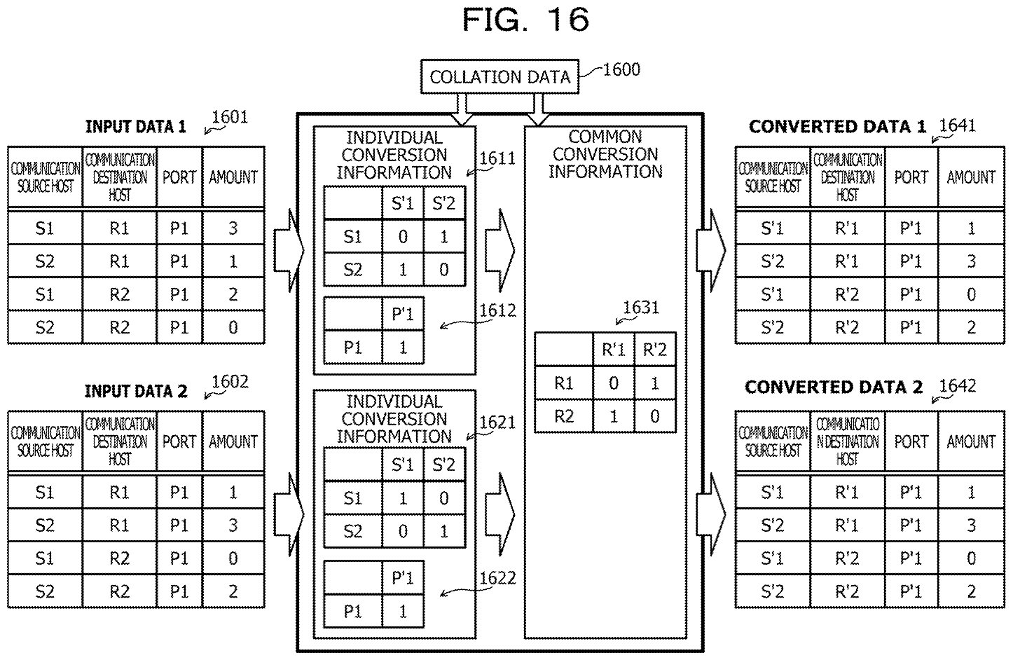

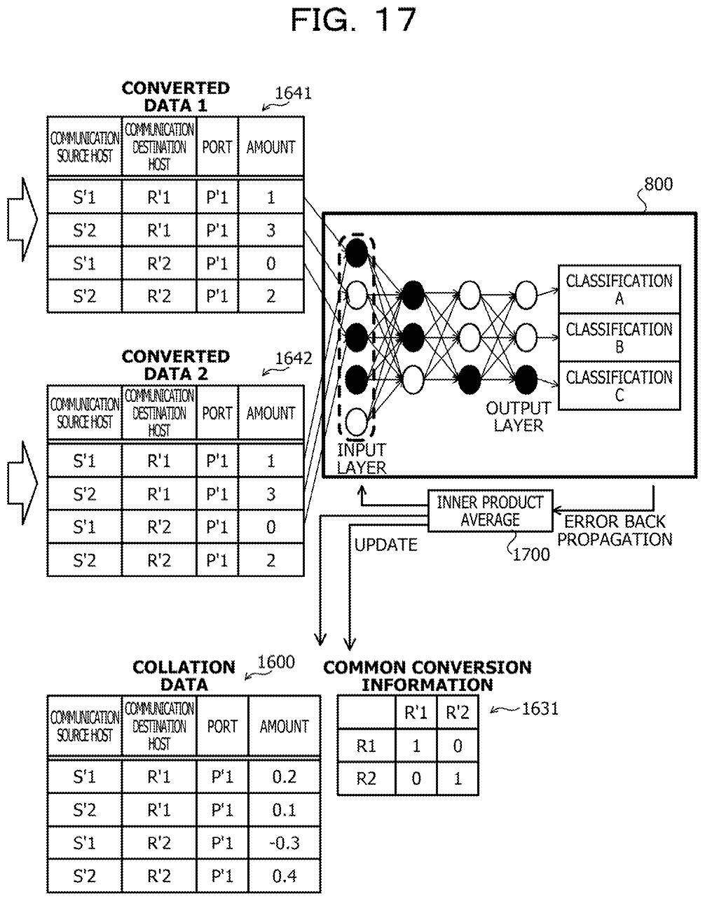

FIGS. 16 and 17 are explanatory diagrams illustrating specific examples of the operation example 2 of the information processing device 100.

In FIG. 16, (16-1) the information processing device 100 includes collation data 1600. The information processing device 100 acquires learning data including input data 1601 and learning data including input data 1602. The information processing device 100 generates random common conversion information 1631.

(16-2) The information processing device 100 experimentally rearranges the records of the input data 1601 and 1602, and generates the converted data for search for searching for the rearrangement pattern of rearranging the records of the input data 1601 and 1602. Next, the information processing device 100 calculates the inner product of the first vector in which the amounts in the converted data for search are arranged in order, and the second vector in which the amounts in the collation data 1600 are arranged in order, as the similarity of the converted data for search with the collation data 1600, for each converted data for search. Then, the information processing device 100 generates individual conversion information 1611 and 1612 indicating the rearrangement pattern in which the similarity obtained from the inner product is maximized, for the input data 1601. Furthermore, the information processing device 100 generates individual conversion information 1621 and 1622 indicating the rearrangement pattern in which the similarity obtained from the inner product is maximized, for the input data 1602.

(16-3) The information processing device 100 generates converted data 1641 by converting the order of the records of the input data 1601 on the basis of the common conversion information 1631 and the individual conversion information 1611 and 1612. Furthermore, the information processing device 100 generates converted data 1642 by converting the order of the records of the input data 1502 on the basis of the common conversion information 1631 and the individual conversion information 1621 and 1622. Next, description of FIG. 17 will be given.

In FIG. 17, (17-1) the information processing device 100 inputs the converted data 1641 to the nodes of the input layer of the neural network 800. Next, the information processing device 100 calculates the difference between the output vector in which the output values of the nodes of the output layer of the neural network 800 are arranged and the output vector in which the output values in the teaching data are arranged as the output error. Then, the information processing device 100 calculates the input error by error back propagation on the basis of the output error, and calculates the error vector for the converted data 1641 in which the input errors are arranged in order. Similarly, the information processing device 100 inputs the converted data 1642 to the nodes of the input layer of the neural network 800, and calculates the error vector for the converted data 1642.

(17-2) The information processing device 100 experimentally changes the first amount of the collation data 1600 by 1, and converts the order of the records of the input data 1601 and 1602, thereby generating the test data for the input data 1601 and 1602. Then, the information processing device 100 calculates the variation between the input vector in which the amounts of the test data for the input data 1601 are arranged in order and the input vector in which the amounts of the converted data 1641 generated from the input data 1601 are arranged in order. Next, the information processing device 100 calculates the variation vector for the converted data 1641 in which the calculated variations are arranged in order. Then, the information processing device 100 calculates the inner product of the calculated error vector and the variation vector for the converted data 1641. Furthermore, the information processing device 100 similarly calculates the inner product for the converted data 1642.

(17-3) The information processing device 100 calculates an average value 1700 of the inner products of the converted data 1641 and 1642. Here, in the case where the average value 1700 of the inner products is negative, the information processing device 100 determines that the change direction of experimentally changing the first amount of the collation data 1600 is the direction of reducing the output error. On the other hand, in the case where the average value 1700 of the inner products is positive, the information processing device 100 determines that the change direction of experimentally changing the first amount of the collation data 1600 is the direction of expanding the output error. Then, the information processing device 100 changes the first amount of the collation data 1600 on the basis of the determination result. The information processing device 100 similarly changes the second and subsequent amounts of the collation data 1600.

(17-4) The information processing device 100 experimentally changes the correspondence indicated by the common conversion information 1631 and converts the order of the records of the input data 1601 and 1602, thereby generating the test data of the input data 1601 and 1602. Then, the information processing device 100 calculates the variation between the input vector in which the amounts of the test data for the input data 1601 are arranged in order and the input vector in which the amounts of the converted data 1641 generated from the input data 1601 are arranged in order. Next, the information processing device 100 calculates the variation vector for the converted data 1641 in which the calculated variations are arranged in order. Then, the information processing device 100 calculates the inner product of the calculated error vector and the variation vector for the converted data 1641. Furthermore, the information processing device 100 similarly calculates the inner product for the converted data 1642.

(17-5) The information processing device 100 calculates the average value 1700 of the inner products of the converted data 1641 and 1642. Here, in the case where the average value 1700 of the inner products is negative, the information processing device 100 determines that the change direction of experimentally changing the correspondence indicated by the common conversion information 1631 is the direction of reducing the output error. On the other hand, in the case where the average value 1700 of the inner products is positive, the information processing device 100 determines that the change direction of experimentally changing the correspondence indicated by the common conversion information 1631 is the direction of expanding the output error. Then, the information processing device 100 changes the correspondence indicated by the common conversion information 1631 regarding the first common item on the basis of the determination result.

(17-6) The information processing device 100 updates the parameters of the neural network 800 on the basis of the output error. Thereby, the information processing device 100 may improve the learning accuracy of machine learning and facilitate learning of the highly accurate neural network 800 and collation data 1600.

Furthermore, the information processing device 100 can generate and update the common conversion information 1631 independently of the collation data 1600, Therefore, the information processing device 100 may suppress an increase in the processing amount in the case of varying the collation data 1600, For example, in the case of implementing machine learning using a mini-batch, the information processing device 100 can suppress an increase in the processing amount needed when updating common conversion information 1631 on the basis of only the input data in the mini-batch.

### Overall Processing Procedure in Operation Example 2

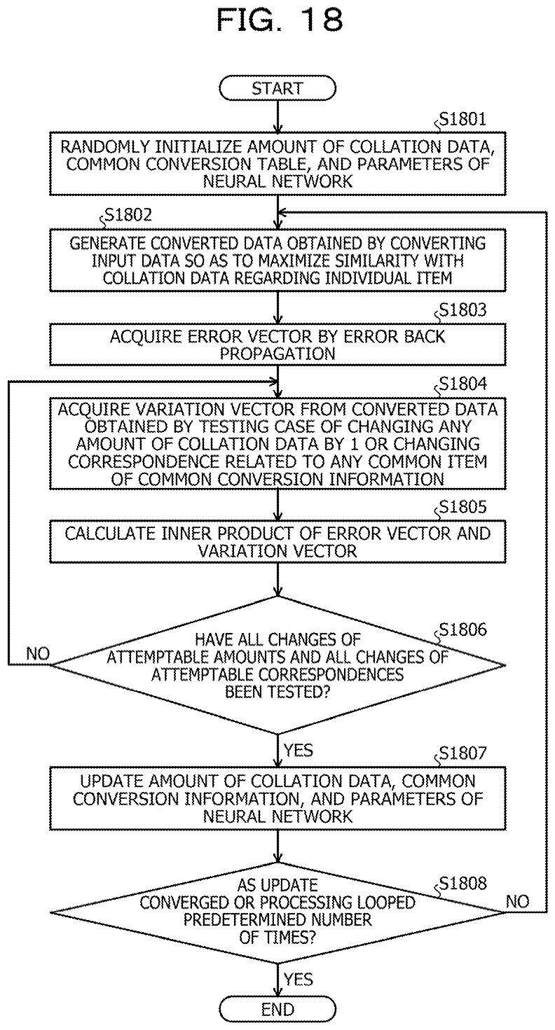

Next, an example of an overall processing procedure executed by the information processing device 100 in the operation example 2 will be described with reference to FIG. 18, The overall processing is implemented by, for example, the CPU 301, the storage area of the memory 302, the recording medium 305, or the like, and the network I/F 303 illustrated in FIG. 3.

FIG. 18 is a flowchart illustrating an example of the overall processing procedure according to the operation example 2. In FIG. 18, the information processing device 100 randomly initializes the amount of the collation data, a common conversion table, and the parameters of the neural network (step S1801),

Next, the information processing device 100 generates the converted data obtained by converting the input data so as to maximize the similarity with the collation data regarding an individual item (step S1802). Then, the information processing device 100 acquires the error vector by error back propagation (step S1803).

Next, the information processing device 100 acquires the variation vector from the converted data obtained by testing a case of changing any amount of the collation data by 1 or changing the correspondence regarding any common item of the common conversion information (step S1804). Then, the information processing device 100 calculates the inner product of the error vector and the variation vector (step S1805).

Next, the information processing device 100 determines whether all of changes in attemptable amounts and all of changes in attemptable correspondences have been tested in step S1804 (step S1806), Here, in a case where there is a change in an untested amount or a change in an untested correspondence (step S1806: No), the information processing device 100 returns to the processing of step S1804. On the other hand, in a case where all the changes have been tested (step S1806: Yes), the information processing device 100 proceeds to processing of step S1807.

In step S1807, the information processing device 100 updates the amount of the collation data, the common conversion information, and the parameters of the neural network on the basis of the calculated inner product (step S1807). Next, the information processing device 100 determines whether the update has converged in step S1807 or whether the series of processing in steps S1801 to S1807 have been looped a predetermined number of times (step S1808). Here, in the case where the update has not converged and the series of processing have not been looped a predetermined number of times (step S1808: No), the information processing device 100 returns to the processing of step S1802.

On the other hand, in the case where the update has converged or the series of processing have been looped a predetermined number of times (step S1808; Yes), the information processing device 100 terminates the entire processing. Thereby, the information processing device 100 may improve the learning efficiency. Furthermore, since the information processing device 100 updates the common conversion information on the basis of the calculated inner product, the information processing device 100 may reduce the processing amount.

In the above description, the case where the converted data has the same data structure as the input data has been described. However, an embodiment is not limited to the case. For example, an input vector after rearranging the input values of the input data without rearranging the records of the input data may be treated as the converted data.

As described above, the information processing device 100 can generate the common conversion information 120 commonly applied to a plurality of data in association with one or more items among a plurality of items. The information processing device 100 can generate the individual conversion information 130 individually applied to each data in association with remaining items excluding one or more items of the plurality of items. The information processing device 100 can generate the converted data obtained by converting the correspondence of each data of the plurality of data on the basis of the generated common conversion information 120 and individual conversion information 130. The information processing device 100 can update the collation data 140 and the learner 110 on the basis of the generated converted data. Thereby, the information processing device 100 may improve the learning accuracy.

The information processing device 100 can generate the common conversion information 120 on the basis of the similarity between the test data and the collation data 140 obtained by converting the correspondence between the input value and the input node, of each data of the plurality of data. Thereby, the information processing device 100 can easily obtain the common conversion information 120 with accuracy.

The information processing device 100 can further update the common conversion information 120 on the basis of the generated converted data. Thereby, the information processing device 100 can generate and update the common conversion information 120 independently of the collation data 140. Therefore, the information processing device 100 varies the collation data 140 to update the collation data 140 and the learner 110, and can suppress the increase in the processing amount needed when generating the converted data.

According to the information processing device 100, the similarity can be expressed by the inner product of the first vector in which the input values in the test data are arranged and the second vector in which the input values in the collation data 140 are arranged. Thereby, the information processing device 100 can easily treat the similarity.

The information processing device 100 can calculate the error vector in which the errors of the input values in the converted data generated from the data in the case where the converted data generated from the data is input to the learner 110 are arranged, by error back propagation. The information processing device 100 can calculate the variation vector in which the differences in the input values between the converted data generated from the data and another converted data generated from data in the case of varying the common conversion information 120 or the collation data 140 are arranged. The information processing device 100 can update the collation data 140 and the learner 110 on the basis of the error vector and the variation vector. Thereby, the information processing device 100 can easily obtain the collation data 140 and the learner 110 with accuracy.

The information processing device 100 can generate the converted data obtained by converting the correspondence of the data to be classified on the basis of the generated common conversion information 120 and the updated collation data 140, and input the converted data to the updated learner 110. The information processing device 100 can classify the data to be classified on the basis of the output data output from the learner 110 in response to the input of data to the learner 110. Thereby, the information processing device 100 enables the learner 110 to be available to the user.

Note that the learning method described in this embodiment can be implemented by a computer such as a personal computer or a workstation executing a prepared program. The learning program described in the present embodiment is recorded on a computer-readable recording medium such as a hard disk, flexible disk, compact disk read only memory (CD-ROM), magneto-optical disk (MO), or digital versatile disc (DVD), and is read from the recording medium to be executed by the computer. Furthermore, the learning program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a machine-learning program which causes a processor to perform processing, the processing comprising:
generating common conversion information to be commonly applied to a plurality of data, each of the plurality of data including a combination of an item value of each item of a plurality of items and an input value in association with one or more items of the plurality of items, the common conversion information being for converting a correspondence between each of the input values in the plurality of data and each of input nodes in a machine learner in a case of inputting the plurality of data to the machine learner;
generating individual conversion information to be individually applied to each of the plurality of data, the individual conversion information being for converting the correspondence of each of the plurality of data, in association with a remaining item excluding the one or more items of the plurality of items, on the basis of a similarity between test data and collation data obtained by converting the correspondence for each of the plurality of data;
generating converted data obtained by converting the correspondence of each of the plurality of data on the basis of the generated common conversion information and the generated individual conversion information; and
updating the collation data and the learner on the basis of the generated converted data.

2. The non-transitory computer-readable storage medium according to claim 1, wherein
the processing of generating common conversion information includes generating the common conversion information on the basis of the similarity between test data and collation data obtained by converting the correspondence for each of the plurality of data.

3. The non-transitory computer-readable storage medium according to claim 1, wherein
the updating processing includes further updating the common conversion information on the basis of the generated converted data.

4. The non-transitory computer-readable storage medium according to claim 1, wherein
the similarity is expressed by an inner product of a first vector in which input values in the test data are arranged and a second vector in which input values in the collation data are arranged.

5. The non-transitory computer-readable storage medium according to claim 1, the processing further comprising:
calculating, for each of the plurality of data, by error back propagation, an error vector in which errors of input values in the converted data generated from the data in a case of inputting the converted data generated from the data to the learner are arranged; and
calculating, for each of the plurality of data, a variation vector in which differences in input values between the converted data generated from the data and another converted data generated from the data in a case of varying the common conversion information or the collation data are arranged, wherein
the updating processing includes updating the collation data and the learner on the basis of the error vector and the variation vector.

6. The non-transitory computer-readable storage medium according to claim 1, the processing further comprising:
generating converted data obtained by converting the correspondence of data to be classified on the basis of the generated common conversion information and the updated collation data, and inputting the converted data to the updated learner; and
classifying the data to be classified on the basis of output data output from the learner in response to the input of the converted data to the learner.

7. A machine-learning method implemented by a computer, the method comprising:
generating common conversion information to be commonly applied to a plurality of data, each of the plurality of data including a combination of an item value of each item of a plurality of items and an input value in association with one or more items of the plurality of items, the common conversion information being for converting a correspondence between each of the input values in the plurality of data and each of input nodes in a machine learner in a case of inputting the plurality of data to the machine learner;
generating individual conversion information to be individually applied to each of the plurality of data, the individual conversion information being for converting the correspondence of each of the plurality of data, in association with a remaining item excluding the one or more items of the plurality of items, on the basis of a similarity between test data and collation data obtained by converting the correspondence for each of the plurality of data;
generating converted data obtained by converting the correspondence of each of the plurality of data on the basis of the generated common conversion information and the generated individual conversion information; and
updating the collation data and the learner on the basis of the generated converted data.

8. An information processing device comprising
a memory; and
a processor circuit coupled to the memory, the processor circuit being configured to:
generate common conversion information to be commonly applied to a plurality of data, each of the plurality of data including a combination of an item value of each item of a plurality of items and an input value in association with one or more items of the plurality of items, the common conversion information being for converting a correspondence between each of the input values in the plurality of data and each of input nodes in a machine learner in a case of inputting the plurality of data to the machine learner;
generate individual conversion information to be individually applied to each of the plurality of data, the individual conversion information being for converting the correspondence of each of the plurality of data, in association with a remaining item excluding the one or more items of the plurality of items, on the basis of a similarity between test data and collation data obtained by converting the correspondence for each of the plurality of data;
generate converted data obtained by converting the correspondence of each of the plurality of data on the basis of the generated common conversion information and the generated individual conversion information; and
update the collation data and the learner on the basis of the generated converted data.
